(19) United States
(12) Patent Application Publication
(10) Pub. No.: US 2026/0133734 A1
(43) Pub. Date: May 14, 2026

(54) STORAGE MEDIUM, METHOD, AND INFORMATION PROCESSING APPARATUS

(71) Applicant: CANON KABUSHIKI KAISHA, Tokyo (JP)

(72) Inventor: DAICHI HIDAKA, Tokyo (JP)

(21) Appl. No.: 19/376,661

(22) Filed: Oct. 31, 2025

(30) Foreign Application Priority Data
Nov. 12, 2024 (JP) 2024-197636

(51) Int. Cl. G06F 3/12

(52) U.S. Cl. CPC G06F 3/1254; G06F 3/1204; G06F 3/1228; G06F 3/1252

(57) ABSTRACT

A method for supporting a standard driver provided by a provider of an operating system of an information processing apparatus includes causing the standard driver of the information processing apparatus to execute, by executing an application program, a changing process for changing a page order of a plurality of pages of image data generated by an image editing application program to a page order for reverse printing in an order opposite to the page order, and after the standard driver has completed the changing process, causing the operating system of the information processing apparatus to instruct the standard driver, by executing the application program, to generate print data based on the image data.

### BACKGROUND

### Field of the Technology

The present disclosure relates to a storage medium, a method, and an information processing apparatus.

### Description of the Related Art

There is a known configuration of control software for printing devices in which a printer driver is installed on a host computer and communicates print instructions to a connected printing device. An operating system (OS), which serves as the basic software, is installed in the host computer. The printer driver is configured according to the specifications defined by the OS and operates when invoked by the OS. A vendor that provides the printing device provides a printer driver conforming to the specifications of the OS, thereby providing a means for instructing the printing device to print using the OS.

Windows® has recently provided a standard class driver (hereinafter also referred to as "standard driver") that can be commonly used by printing devices provided by multiple vendors. Such a standard driver is packed in the OS package and can easily be used by connecting a desired printing device to the host computer. This eliminates the need for separately installing a device-specific printer driver suitable for the printing device, which enhances the convenience. The standard driver is configured to allow printing functions to be specified in accordance with PrintDeviceCapabilities (PDC) generated based on information obtained from a connected printing device. This enables users of the standard driver to specify printing functions according to the capabilities of the connected printing device, even though the users are using a single standard driver.

The standard driver can be associated with an application for extending the functions (hereinafter also referred to as "extension application"). The extension application can be provided by a vendor that provides the printing device. The extension application can provide functions that cannot be implemented only by the standard driver (extended functions) by editing the PDC generated by the standard driver. Editing the PDC refers to rewriting existing printing functions into the PDC generated by the standard driver, deleting a printing function, or adding a new printing function.

The extension application can edit intermediate print data generated by the standard driver. This enables layout functions not supported by the standard driver (for example, allocation printing in which multiple pages are laid out on a single sheet, also referred to as N-in-1 printing).

Japanese Patent Laid-Open No. 2021-108001 discloses a technique for extending the functions of a standard driver by editing the PDC using an extension application based on information obtained from a printer.

Known extension applications can extend the functions of the standard driver by editing the PDC based on information obtained from a printer. However, there exists a need for an extension application that extends the functions of the standard driver to provide better functionality.

### SUMMARY

According to an aspect of the present disclosure, there is provided a non-transitory computer-readable storage medium storing an application program that is configured to cooperate with a standard driver provided by a provider of an operating system of an information processing apparatus, wherein the application program, when executed, causes the information processing apparatus to perform a control method including causing the standard driver of the information processing apparatus to execute a changing process of changing a page order of a plurality of pages of image data generated by an image editing application program to a page order for reverse printing in an order opposite to the page order, and after the standard driver has completed the changing process, causing the operating system of the information processing apparatus to instruct the standard driver to generate print data based on the image data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the hardware configuration of a printing system.

FIGS. 2A and 2B are diagrams schematically illustrating the software configuration of the printing system.

FIG. 3 is a diagram illustrating an example of PDC generated by print-data generation software.

FIG. 4 is a diagram illustrating an example of PDC edited by a printing-function extension unit.

FIGS. 5A to 5C are diagrams illustrating examples of a print settings screen displayed by a print-settings-screen extension unit.

FIG. 6 is a flowchart of a sequence of processes executed when a print-data editing unit receives a print instruction from an OS.

FIG. 7 is a flowchart of a sequence of processes executed when the print-data generation software receives a print-data generation instruction from the print-data editing unit.

FIGS. 8A to 8D are diagrams illustrating the state of print data when a sequence of processes is executed by the print-data editing unit.

FIG. 9 is a flowchart of a sequence of processes executed when the print-data editing unit receives a print instruction from the OS.

FIG. 10 is a flowchart of a sequence of processes executed when the print-data editing unit receives a print instruction from the OS.

FIG. 11 is a flowchart of a sequence of print-data editing processes performed by the print-data editing unit.

FIG. 12 is a diagram illustrating an example of response information provided when a Get-Printer-Attributes command is issued to the printing device.

FIG. 13 is a table illustrating an example of a list of print settings and setting values thereof.

### DESCRIPTION OF THE EMBODIMENTS

Embodiments of the present technique will be described hereinbelow with reference to the accompanying drawings. It is to be understood that the following embodiments do not limit the present technique according to the claims and that not all of the combinations described in the embodiments are required for the solution of the present technique.

Like components are denoted by like reference numerals, and repeated description is omitted.

### First Embodiment

### Hardware Configuration of Printing System

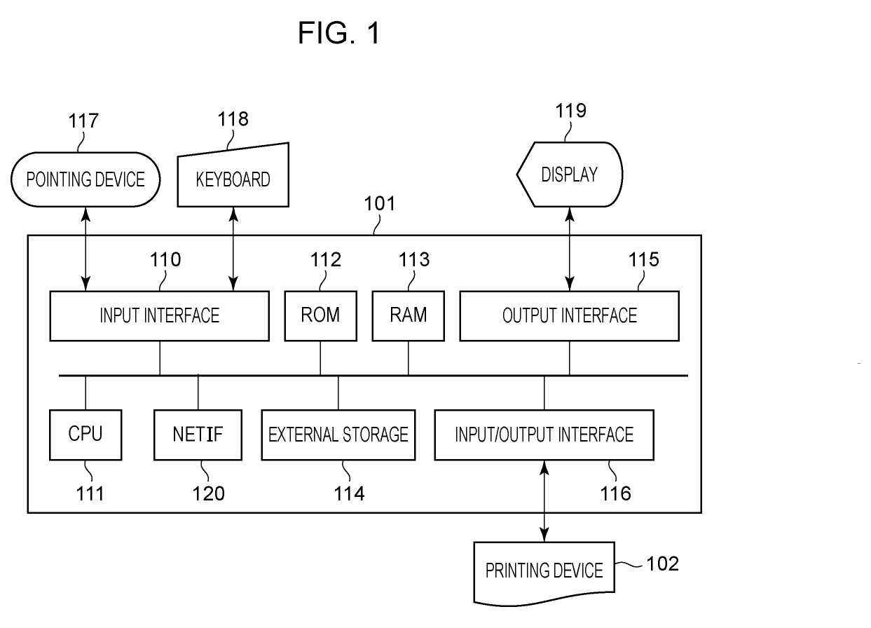

FIG. 1 is a block diagram illustrating the hardware configuration of a printing system. In FIG. 1, a host computer 101 is an example of an information processing apparatus and includes an input interface 110, a central processing unit (CPU) 111, a read-only memory (ROM) 112, a random-access memory (RAM) 113, an external storage 114, an output interface 115, and an input/output interface 116. The input interface 110 is connected to input devices, such as a keyboard 118 and a pointing device 117. The output interface 115 is connected to a display device such as a display 119. A network interface (NETIF) 120 performs control for transferring data to/from an external device via a network.

The ROM 112 stores an initialization program.

The RAM 113 is used as a work memory or the like in executing various programs stored in the external storage 114 to allow the various programs to operate in the host computer 101.

Examples of the external storage 114 include a hard disk drive (HDD) and a solid-state drive (SSD). The external storage 114 stores application programs, an operating system (OS), print-data generation software, and various other types of data.

In this embodiment, the CPU 111 executes processes according to the procedure of the program stored in the ROM 112 to implement the functions of the host computer 101 and the processes shown in the flowcharts, described below. A printing device 102 is connected to the host computer 101 via the input/output interface 116. Here, the host computer 101 and the printing device 102 are separately configured, but they may be configured as a single information processing apparatus. The printing device 102 will be described using an ink-jet printer that performs printing by ejecting ink onto a sheet such as paper, as an example. Alternatively, printing may be performed using another method (for example, an electrophotographic method). The host computer 101 may be a desktop personal computer, a smartphone, or a notebook personal computer.

The present embodiment will be described using a locally connected ink-jet printer as an example of the printing device 102. The printing device 102 may be, for example, a laser printer (locally connected or cloud-connected). The present disclosure is not limited to these two types, and may also be of other device types or have a configuration that determines the connection scheme. The local connection refers to a configuration in which the host computer 101 and the printing device 102 are connected to enable direct communication via the input/output interface 116 or the NETIF 120. The cloud connection refers to a connection scheme in which the host computer 101 instructs the printing device 102 to perform printing via a cloud print service (not shown) on the Internet via the NETIF 120. Specific examples of Feature and Option in the diagrams exemplified below are for a printing device whose device type is an ink-jet printer unless otherwise specified.

### Configuration of Printing System Centered on Software

### Software Configuration of Printing System

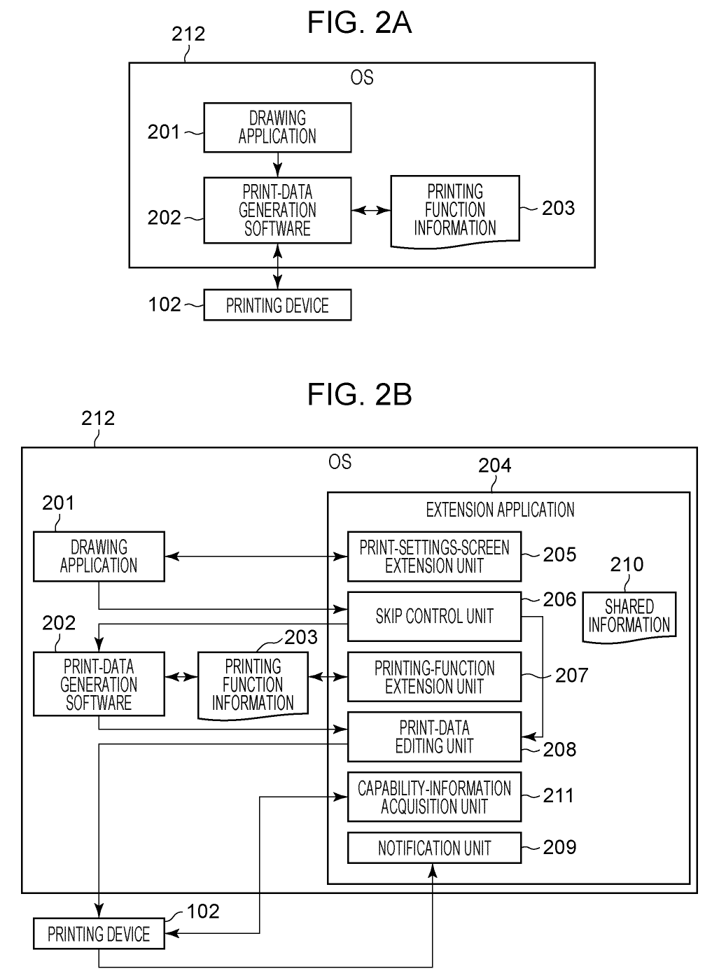

FIGS. 2A and 2B schematically illustrate the software configuration of the printing system. The following description assumes a printing system using the host computer 101 running Microsoft® Windows® 11 as its operating system (OS) 212. A configuration will be described in which an IPP class driver provided with Windows® 11 is used as print-data generation software 202. The IPP class driver is a printer driver that executes a print process in accordance with the specifications of a standard print protocol called the Internet print protocol (IPP). The IPP class driver is provided by the provider of the OS 212 and is packed in the OS 212. The IPP class driver is not a dedicated printer driver that is specific to a particular model of the printing device 102 but rather a standard class driver that can be commonly used by multiple printing devices provided by multiple vendors. In other words, the IPP class driver can generate print data that can be printed by multiple printing devices provided by multiple printer vendors (printer manufacturers). The IPP class driver can transmit the print data to the multiple printing devices provided by the multiple manufacturers. FIG. 2A is a diagram illustrating a general configuration in which an extension application 204 is not associated with the print-data generation software 202 and the printing device 102.

A drawing application 201 is software for creating contents to be printed (drawing data). Examples include image editing application programs such as a document creation application and a spreadsheet application. In response to a print request from a user, the drawing application 201 issues a print instruction to the OS 212. The print instruction includes print setting information for instructions for the operations of the print-data generation software 202 and the printing device 102. The print setting information is also referred to as PrintTicket (hereinafter abbreviated as "PT").

The drawing application 201 can display a print settings screen provided by the print-data generation software 202, the OS 212, or the drawing application 201 to output print setting information. The print settings screen includes setting items indicating configurable printing functions (hereinafter referred to as "control items") and control items indicating the setting values thereof in accordance with capability information acquired from the print-data generation software 202 (information configurable as print settings). The capability information is also referred to as PrintCapabilities (hereinafter abbreviated as "PC"). The print-data generation software 202 determines the PC based on printing-function information 203. The printing-function information 203 is data indicating all configurable printing functions, their setting values, and a printing function in which an exclusive relationship between setting values is described. The printing-function information 203 is also referred to as print device capabilities (PDC). The PDC 203 is included in the configuration file of the print-data generation software 202 and is dynamically generated by the print-data generation software 202. Specifically, the print-data generation software 202 can be configured to acquire the attribute data of the printing device 102 from the printing device 102 and generate the PDC 203 according to attribute information in the acquired attribute data. The attribute data of the printing device 102, acquired from the printing device 102, is a response acquired by issuing a Get-Printer-Attributes operation of the Internet Printing Protocol (IPP) to the printing device 102. The response includes attribute information (Features) indicating functions that can be designated by the printing device 102 (the capabilities of the printing device 102) and setting values (Options) relating to the attribute information. This response is stored in the RAM 113.

With this configuration, the print-data generation software 202 can be configured to enable the user to specify printing functions available across all the printing devices 102 according to the connected printing device 102. In other words, even if printing devices with different functions or printing devices developed by different vendors are connected, the print-data generation software 202 enables the user to specify available printing functions according to the connected printing device 102.

The OS 212 generates intermediate print data (also referred to as input data or image data) based on a print instruction output from the drawing application 201 and provides the data to the print-data generation software 202. The data that the drawing application 201 outputs for printing is Graphic Device Interface format data (GDI format data) or Extensible Markup Language (XML) Paper Specification format data (XPS format data). A case is assumed where the IPP class driver is used as the print-data generation software 202. In this case, if the data that the drawing application 201 outputs is GDI format data, the OS 212 converts the GDI format data output from the drawing application 201 to XPS format data. The converted XPS format data is provided to the print-data generation software 202 as intermediate print data. If the data that the drawing application 201 outputs is XPS format data, the OS 212 provides the XPS format data to the print-data generation software 202 as intermediate print data. The intermediate print data includes drawing data, which is information on a picture formed on paper and print setting information set by the user.

The print-data generation software 202 is, for example, an IPP class driver, which converts the acquired intermediate print data to print data interpretable by the printing device 102 and transmits it to the printing device 102. The print data includes drawing data, which is information on a picture formed on paper and print-setting attribute information (attribute information that specifies print settings) generated based on print setting information set by the user. The print-setting attribute information includes attribute information (Feature) indicating functions that can be specified by the printing device 102 (the capabilities of the printing device 102) and setting values (Option) associated with the attribute information.

The printing device 102 prints on paper based on print data sent from the print-data generation software 202. At that time, the printing device 102 forms drawing data included in the print data in accordance with the print-setting attribute information included in the print data. The print-setting attribute information includes print quality (image quality priority, speed priority, etc.), attribute information for specifying two-sided printing and the like, and setting values thereof. For example, when the print-setting attribute information includes attribute information for specifying two-sided printing and setting values therefor, the printing device 102 executes two-sided printing.

FIG. 2B is a diagram illustrating a configuration in which the extension application 204 is associated with the print-data generation software 202 and the printing device 102. The configurations and processes not specifically described herein are equivalent to those shown in FIG. 2A.

The extension application 204 is software for extending the functions of the print-data generation software 202 and is not contained (packed) in advance in the OS 212. For this reason, the user is required to operate the host computer 101 to download the extension application 204 from the server via the Internet and install it. Alternatively, the extension application 204 may be automatically installed in response to connection of the printing device 102 to the host computer 101. Specifically, when the printing device 102 is connected to the host computer 101, the OS 212 obtains device identification information from the printing device 102. The OS 212 may download the extension application 204 corresponding to the obtained device identification information from the server via the Internet and install it. In other words, the print-data generation software 202 and the extension application 204 are stored in the host computer 101 as different files.

The print-data generation software 202 and the extension application 204 may be updated to a new version. These update processes are carried out at separate times. In other words, the timing when the print-data generation software 202 is obtained and the timing when the extension application 204 is obtained by the host computer 101 are different. The trigger to obtain the print-data generation software 202 and the trigger to obtain the extension application 204 by the host computer 101 are also different. When the extension application 204 is installed, the OS 212 associates the extension application 204 with the print-data generation software 202 and the printing device 102.

The extension application 204 described in this embodiment includes a print-settings-screen extension unit 205, a skip control unit 206, a printing-function extension unit 207, a print-data editing unit 208, a notification unit 209, and a capability-information acquisition unit 211. The extension application 204 further includes shared information 210 accessible from each unit. The actual form of the shared information 210 is a file stored in the external storage 114 or information stored on the RAM 113. The extension application 204 writes and reads information to/from the shared information 210 by using an application programming interface (API) provided by the OS 212.

The extension application 204 may terminate the operation every time the process of each unit is completed. In that case, the OS 212 activates the extension application 204 every time a request to use each unit is provided. Other configurations are also possible. For example, when the process of the print-settings-screen extension unit 205 is completed, the OS 212 terminates execution of the extension application 204, whereas even upon completion of the process of the skip control unit 206, the OS 212 may keep the extension application 204 running.

Furthermore, the extension application 204 may cancel a process being executed by each unit. If a process is cancelled, the job being processed in the print queue is deleted by the OS 212.

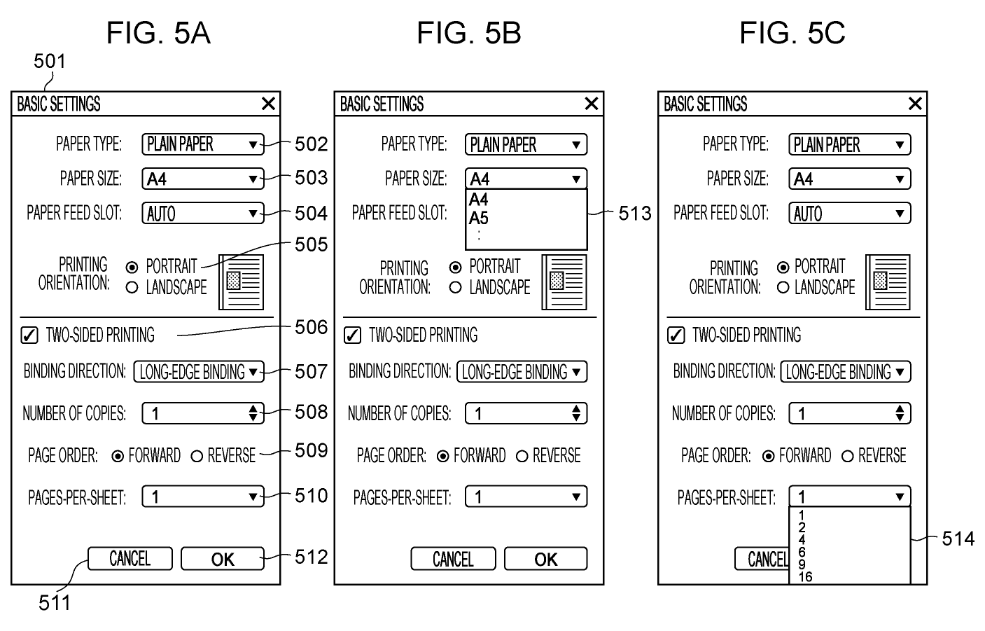

In response to a print request from the user, the drawing application 201 issues a print instruction to the OS 212. With this configuration as well, the drawing application 201 can display a print-settings screen, as with the configuration of FIG. 2A. With this configuration, a print settings screen provided by the extension application 204 is displayed. Specifically, a print settings screen provided by the print-settings-screen extension unit 205 of the extension application 204 is displayed. Whether the print settings screen provided by the print-settings-screen extension unit 205 is displayed depends on a user operation. The details of the print-settings-screen extension unit 205 will be described later with reference to FIGS. 5A to 5C.

When the drawing application 201 receives a print request from the user and issues a print instruction to the OS 212, the OS 212 activates the skip control unit 206. The skip control unit 206 controls whether the processing of the print-data generation software 202 is to be skipped. After the skip control processing of the skip control unit 206, the OS 212 generates intermediate print data based on the print instruction output from the drawing application 201 and provides the intermediate print data to the print-data generation software 202. If the skip control by the skip control unit 206 is not performed, the intermediate print data is processed by the print-data generation software 202 to print data that is interpretable by the printing device 102, and the print data is provided to the print-data editing unit 208. In contrast, if the print-data generation software 202 is skipped, the intermediate print data is directly provided to the print-data editing unit 208 without being processed by the print-data generation software 202. This enables the intermediate print data to be processed by the print-data editing unit 208.

The print-data editing unit 208 edits the intermediate print data provided by the OS 212 or the print data processed by the print-data generation software 202. When allocation printing is designated as an example of an editing process, the print-data editing unit 208 modifies the layout of the intermediate print data or the print data based on print setting information for allocation printing received from the OS 212. The print-data editing unit 208 is capable of displaying a graphical user interface (GUI) screen on the display 119, providing functions such as displaying the layout result of the print data or the intermediate print data as a preview screen. While the GUI screen displayed on the display 119 by the print-data editing unit 208 is open, the print data is not transmitted to the printing device 102, and closing the GUI screen initiates a print data transmission process.

After the print-data editing unit 208 edits the intermediate print data or the print data, the print data is provided to the printing device 102. The printing device 102 prints on paper based on the received print data.

When the processing of the print-data generation software 202 is skipped by the skip control unit 206, the print-data editing unit 208 may convert the received intermediate print data to print data that is interpretable by the printing device 102. In order to convert the intermediate print data to print data, a function provided by the OS 212 may be used.

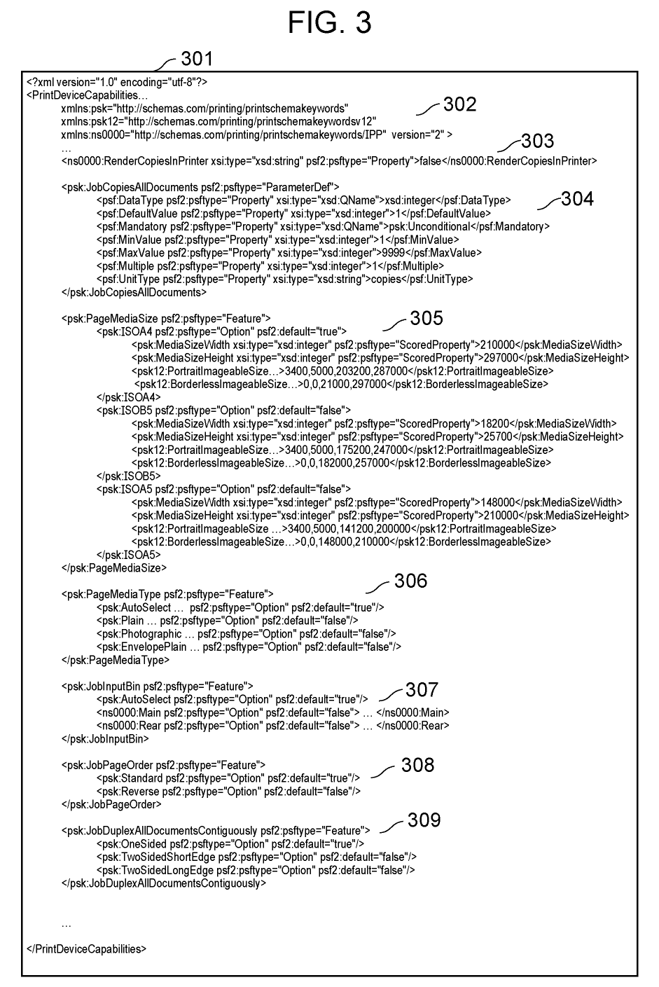

The extension application 204 includes the printing-function extension unit 207. The printing-function extension unit 207 can edit the PDC 203 generated by the print-data generation software 202. The details of the editing of the PDC 203 by the printing-function extension unit 207 will be described later with reference to FIGS. 3, 4, and 12. The edition of the PDC 203 enables the printing-function extension unit 207 to add functions provided by the extension application 204 and functions that are supported by the printing device 102 but not supported by the print-data generation software 202.

When the extension application 204 is first associated with the printing device 102 and the print-data generation software 202, the OS 212 activates the printing-function extension unit 207. The OS 212 may also activate the printing-function extension unit 207 at the start of the OS 212 or another timing. With this configuration, in a case where an optional device (for example, a finisher) is added to the printing device 102 to extend the function for printing, the printing-function extension unit 207 can detect the extended function and add it to the PDC 203.

The extension application 204 further includes the notification unit 209. The notification unit 209 can display a notification to the user in response to the occurrence of an error in the printing device 102. For example, when a print jam error occurs in the printing device 102, the OS 212 detects it and causes the display 119 to display a message using a notification function called a toast notification, which is a function of the OS 212. When the toast notification is pressed by the user, the notification unit 209 of the extension application 204 is invoked by the OS 212, and a user interface (UI) screen of the notification unit 209 is displayed. The UI screen of the notification unit 209 is capable of displaying, for example, a detailed message of a paper-out error and instructions for loading paper.

Once the extension application 204 transmits print data to the printing device 102, it is no longer possible to display screens such as a guide associated with the print data during processing by each unit.

The configuration of the extension application 204 for implementing this embodiment is not limited to one that includes all of the above-described functions (units) and may include only some of the functions or additional functions. The extension application 204 may also be simply referred to as printing software. The extension application 204 includes at least one of the following functions, as described above.

A function to display a settings screen (the print-settings-screen extension unit 205).

A function to control whether to skip the processing by the print-data generation software 202 (the skip control unit 206).

A function to edit print data to be input to a printing device 102 (the print-data editing unit 208).

A function to extend functions that can be specified by the print-data generation software 202 (the printing-function extension unit 207).

A function to display a screen in response to the occurrence of an error in the printing device 102 (the notification unit 209).

A function to acquire capability information from the printing device 102 (the capability-information acquisition unit 211)

### Example of PDC Editing by Printing-Function Extension Unit

First, the print-data generation software 202 acquires capability information of the printing device 102 connected to the host computer 101 and generates the PDC 203 based on the information. The capability information acquired from the printing device 102 includes information that can be set by the user as print settings. The OS 212 activates the printing-function extension unit 207 of the extension application 204 at a timing at which the extension application 204 is associated with a print queue for the printing device 102 and issues a request to edit the PDC 203 or another timing. The OS 212 may activate the printing-function extension unit 207 at a timing at which a print settings screen is opened by the print-settings-screen extension unit 205, not at the timing at which the extension application 204 is first associated, and issues a request to edit the PDC 203. Upon receiving a request to edit the PDC 203 from the OS 212, the printing-function extension unit 207 acquires the PDC 203 generated by the print-data generation software 202 and starts to edit the PDC 203.

Next, the details of the PDC 203 generated by the print-data generation software 202 will be described.

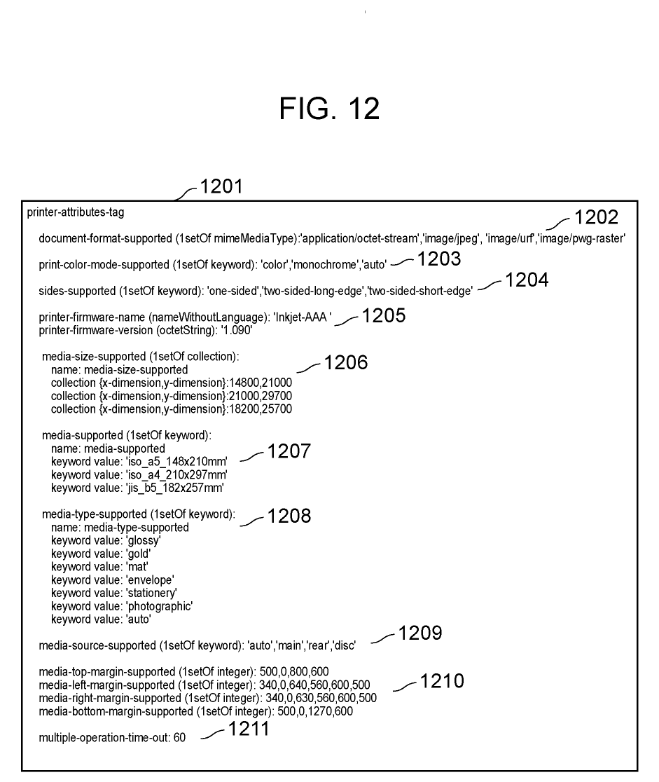

Here, an example of a response that the print-data generation software 202 acquires by issuing a Get-Printer-Attributes operation of the IPP to the printing device 102 will be described with reference to FIG. 12. Information 1201 is an example of the response acquired by issuing a Get-Printer-Attributes operation of the IPP to the printing device 102. Information 1201 includes attribute information (Feature) indicating functions that can be specified as IPP attributes by the printing device 102, and setting values (Options) associated with the attribute information. As indicated by information 1201, information on functions such as size and media (Feature) and setting values (Options) that can be set for the functions can be acquired from the printing device 102. The "document-format-supported" shown in information 1202 represents print data formats acceptable by the printing device 102. The example of information 1202 indicates that the printing device 102 supports data formats including 'application/octet-stream', 'image/jpeg', 'image/urf', and 'image/pwg-raster'. The "print-color-mode-supported" shown in information 1203 represents color modes that can be specified for printing by the printing device 102. The example of information 1203 indicates that the printing device 102 supports color modes including 'color', 'monochrome', and " auto' (automatic selection). The "sides-supported" shown in information 1204 indicates that the printing device 102 supports one-sided printing and two-sided printing including Two-Sided-Short-Edge (short-edge binding) and Two-Sided-Long-Edge (long-edge binding). The "printer-firmware-name" and "printer-firmware-version" shown in information 1205 indicate that the firmware name of the printing device 102 main body is "Inkjet-AAA", and the version information is "1.090", respectively. The "media-size-supported" shown in information 1206 represents media sizes supported by the printing device 102 in units of 1/100 mm for width and height. The example of information 1206 indicates that the printing device 102 supports printing on A5-, A4-, and B5-size paper. The "media-supported" shown in information 1207 represents the names of media sizes supported by the printing device 102. The "media-type-supported" shown in information 1208 represents media types supported by the printing device 102. The example of information 1208 indicates that printing of the media types including glossy (glossy standard) and gold (glossy gold) is supported. The example of information 1208 also indicates that printing on media types including mat (matte photo paper), stationery (plain paper), photographic (photo paper), and envelope (envelope paper) is supported. The "media-source-supported" shown in information 1209 represents a list of paper feeding methods supported by the printing device 102. The example of information 1209 indicates that the printing device 102 supports printing-paper feeding methods including auto (automatic selection), main (main tray), rear (rear tray), and disc (CD/DVD trays). The "media-top (bottom/right/left)-margin-supported" shown in information 1210 represents the lengths of margins that can be set for printing by the printing device 102 for the top, bottom, right, and left of paper. The example of information 1210 indicates that margins of 5 mm, 0 mm, 8 mm, and 6 mm can be provided at the top of the paper, and that margins of 3.4 mm, 0 mm, 6.4 mm, 5.6 mm, 6 mm, and 5 mm can be provided at the left side of the paper. The example of information 1210 also indicates that margins of 3.4 mm, 0 mm, 6.3 mm, 5.6 mm, 6 mm, and 5 mm can be provided at the right side of the paper and that margins of 0.5 mm, 0 mm, 12.7 mm, and 6 mm can be provided at the bottom of the paper. The example of information 1211 indicates that the minimum time during which the printing device 102 accepts continuous operations from a client device such as the information processing apparatus 101 is 60 seconds. This attribute defines that, when the printing device 102 accepts a specific operation from the information processing apparatus 101, the printing device 102 reserves resources for continuous operations for 60 seconds. If 60 seconds or more have elapsed, the resources are released, and, as a result, any operation performed on the printing device 102 from the information processing apparatus 101 can no longer be processed as a subsequent process. For example, when print data is not transmitted for 60 seconds or more after a print start command is sent from the information processing apparatus 101 to the printing device 102, the print job is cancelled. This attribute prevents unnecessary reservation of resources in the printing device 102 by setting a time limit on continuous operations, thereby enabling efficient resource management of the printing device 102. The attribute values exemplified in information 1202 to information 1211 are mere examples. In practice, attribute values other than those exemplified as their respective attribute values are also included. The example shown in information 1201 is also merely one example. The response acquired by issuing a Get-Printer-Attributes operation of the IPP to the printing device 102 includes attribute information other than the exemplified information.

The print-data generation software 202 acquires information such as information 1201 by issuing a Get-Printer-Attributes operation of the IPP to the printing device 102 and generates the PDC 203 based on the acquired information.

An example of the PDC 203 generated by the print-data generation software 202 is illustrated in information 301 shown in FIG. 3. The PDC 203 is described in the XML format as in information 301 shown in FIG. 3, in which attribute information (Features) indicating functions that can be specified by the printing device 102 and setting values (Options) associated with the attribute information are described.

Information 302 represents character strings each defined as the prefix (Prefix) of a name space (NameSpace) to which each Feature or each Option described in information 304 and information 305, described later, belongs. NameSpace represents a set or scope to which each Feature or Option belongs. NameSpace is used to uniquely identify each Feature or Option when the print-data generation software 202, the OS 212, or the extension application 204 refers to the PDC 203, PT, or PC. For example, NameSpace allows distinguishing whether a Feature or Option having the same name is defined by the OS standard or independently defined by the vendor. Specifically, assume that information 302 is defined as xmlns:psk= "http//schemas.com/printing/printingschemakeywords". In this case, "psk" is added as the prefix of each Feature or Option described in the following information 304 and information 305. This allows defining the Feature or Option as belonging to NameSpace "http//schemas.com/printing/printingschemakeywords" described above. Here, if the aforementioned NameSpace is defined by the OS standard, the Feature or Option can be represented as belonging to the OS standard. In this manner, NameSpace represents a set or scope of each Feature or Option. NameSpace is used to uniquely identify each Feature or Option when the print-data generation software 202, the OS 212, or the extension application 204 refers to the PDC 203, PT, or PC.

Information 303 "RenderCopiesInPrinter" represents whether the printing device 102 itself is capable of copying print data by a desired number for printing. Either "true" or "false" is set as the value of information 303. If the value of information 303 is "true", only one print data is transmitted from the print-data generation software 202 to the printing device 102 even when multiple numbers are to be printed. If the value of information 303 is "false", the print data that the print-data generation software 202 transmits to the printing device 102 needs to include pages corresponding to the multiple numbers to be printed. For example, when print data consisting of two pages is to be printed in three copies, the print-data generation software 202 is required to generate print data consisting of six pages in total by replicating the two-page print data in three copies.

Information 304 represents the definition of a default and the minimum and maximum values of a value allowable as the number of copies printed by the printing device 102. In the example of information 305, the default number of copies is 1, and any value from 1 to 9,999 can be specified.

Information 305 indicates that ISOA4, ISOA5, or ISOB5 can be specified as PageMediaSize (paper size). Here, PageMediaSize represents functions (Features), and ISOA4 and so on represent setting values (Options) for the functions. Also for the functions described below, functions (Features) and setting values (Options) are described in a similar notation.

Information 306 indicates that Plain (plain paper), Photographic (photo paper), or EnvelopePlain (envelope paper) can be specified as PageMediaType (media).

Information 307 indicates that Main (main tray), Rear (rear tray), or Disc (CD/DVD tray) can be specified as JobInputBin (paper feeding method).

Information 308 indicates that Standard (forward order) or Reverse (reverse order) can be specified as JobPageOrder (page order). The print-data generation software 202 generates print data by rearranging it in forward order or reverse order according to the Option set for the Feature.

Information 309 indicates that OneSided (one-sided printing) can be specified as JobDuplexAllDocumentContiguously. Information 309 also indicates that TwoSidedShortEdge(two-sided short-edge binding printing) and TwoSidedLongEdge (two-sided long-edge binding printing) can be specified.

As described above, the print-data generation software 202 acquires information such as information 1201 by issuing a Get-Printer-Attributes operation of the IPP to the printing device 102 and generates the PDC 203 based on the acquired information. In the PDC 203 generated here, only Features and Options already known to the print-data generation software 202 are recorded. In other words, vendor-specific information, such as media including glossy gold and matte photopaper, shown in information 1208 is not recorded in the PDC 203, and only standard media, such as plain paper and photo paper, are recorded in the PDC 203. Thus, among the information 1201 acquired from the printing device 102, only standard Features and Options are recorded in the PDC 203 generated by the print-data generation software 202.

The printing-function extension unit 207 of the extension application 204 edits the PDC 203 generated by the print-data generation software 202. This makes it possible to extend the functions available to the user when printing by the printing device 102 using the print-data generation software 202. Specifically, the printing-function extension unit 207 describes new Features or Options in the PDC 203. This enables addition of functions provided by the extension application 204 and functions that are supported by the printing device 102 but not supported by the print-data generation software 202. In the present embodiment, when the printing-function extension unit 207 extends the printing function, the capability-information acquisition unit 211 of the extension application 204 acquires capability information for the printing device 102. Specifically, the printing-function extension unit 207 uses capability information 1201 acquired by the capability-information acquisition unit 211 of the extension application 204 issuing a Get-Printer-Attributes operation of the IPP.

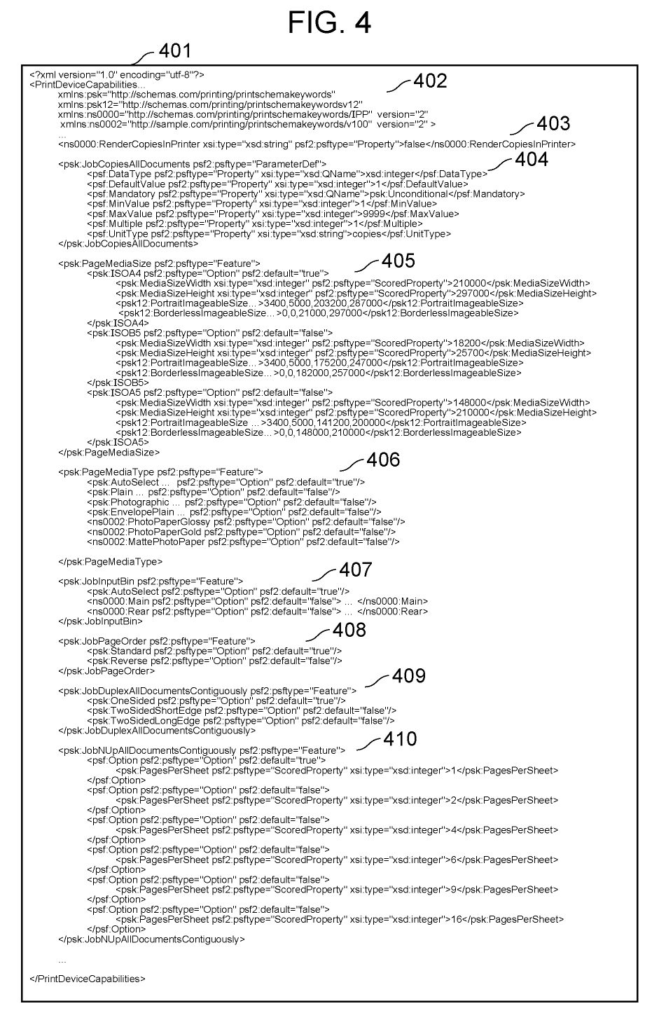

An example of the PDC 203 edited by the printing-function extension unit 207 will be described with reference to information 401 shown in FIG. 4. This is an example in which the printing-function extension unit 207 adds media and an allocation printing function as an editing process for the PDC 203. Information 401 is obtained by editing information 304 using the printing-function extension unit 207. Since the attributes indicated by information 402 to information 405 and information 407 to information 409 are the same as those of information 302 to information 305 and information 307 to information 309, respectively, descriptions thereof will be omitted. The printing-function extension unit 207 adds capability information that is not described in the PDC 203 illustrated in the example of information 301 among the capability information obtained from the printing device 102 by the capability-information acquisition unit 211 to the PDC 203. Specifically, information 406 indicates that the printing-function extension unit 207 has added PhotoPaperGlossy (glossy standard), which is a vendor-specific medium, to PageMediaType. Information 406 also indicates that PhotoPaperGold (glossy gold) and MattePhotoPaper (matte photo paper) are added to PageMediaType. When the printing-function extension unit 207 adds Features or Options to the PDC 203, NameSpace to which each Feature or Option belongs needs to be newly defined. In the example of information 401, NameSpace, "http://sample.com/printing/printschemakeywards/v100", is newly defined with prefix "ns0002" in information 402. Information 406 also indicates that the added medium belongs to NameSpace identified by "ns0002" by adding "ns0002" to the prefix of the added medium.

In this manner, the printing-function extension unit 207 edits the PDC 203 based on the information acquired by the capability-information acquisition unit 211 from the printing device 102. This enables addition of functions provided by the extension application 204 and functions that are supported by the printing device 102 but not supported by the print-data generation software 202.

The printing-function extension unit 207 may add even information that is not acquired from the printing device 102 to the PDC 203. For example, in the case where the print-data editing unit 208 supports a print-data allocation process, the printing-function extension unit 207 may detect it and add the information on the allocation printing function to the PDC 203. Information 410 indicates an example in which the printing-function extension unit 207 has added information on the allocation printing function to the PDC 203. Information 410 indicates that 1-in-1, 2-in-1, 4-in-1, 6-in-1, 9-in-1, and 16-in-1 can be specified as allocation printing.

The addition of functions described as an example of PDC editing by the printing-function extension unit 207 is merely illustrative. In practice, other operations may also be performed, such as addition of functions, deletion of functions, or addition of mutual exclusivity between setting values of printing functions (exclusion information).

### Screen Examples Displayed by Print-Settings-Screen Extension Unit

A print settings screen displayed by the print-settings-screen extension unit 205 will be described with reference to FIGS. 5A to 5C. PC is generated based on the PDC 203 edited by the printing-function extension unit 207. A print settings screen 501 in FIG. 5A is an example of a screen displayed by the print-settings-screen extension unit 205 based on the generated PC. The screen examples illustrated in FIGS. 5A to 5C are merely illustrative, and controls other than those illustrated may also be included. Screen control 502, which can be specified by the user, is a control item for setting the type of paper to be used in printing. Here, for example, items such as "AutoSelect" (automatic selection), "Plain" (plain paper), "Photographic" (photo paper), and "EnvelopePlain" (envelope paper) defined by information 406 can be set. Other configurable items are "PhotoPaperGlossy" (glossy pro), "PhotoPaperGold" (glossy gold), "MattePhotoPaper" (matte photo paper).

Control 503 is a control item for setting a paper size to be used in printing. For example, items such as A4, B5, and A5 defined by information 405 can be set. A list 513 illustrated in FIG. 5B indicates a display state when control 503 is loaded, and the user can select a paper size from the loaded list.

Control 504 is a control item for setting a printing paper feeding method for the printing device 102. Here, items such as "AutoSelect" (automatic selection), "Main" (main tray), "Rear" (rear feed), "Disc" (CD/DVD feed), defined by information 407 can be set. Control 505 is a control item for setting print orientation, in which portrait and landscape can be set. Control 506 is a control item for switching between enabling and disabling two-sided printing. Control 507 is a control item for setting a binding direction at two-sided printing, such as long-edge binding and short-edge binding. Control 508 is a control item for setting the number of copies to be printed, allowing the user to specify the number of copies within a range defined by information 404. Control 509 is a control item for specifying the page order of print data, allowing the user to designate forward or reverse order generation by the print-data generation software 202. Control 510 is a control item for specifying the pages-per-sheet of the allocation printing function. List 514 illustrated in FIG. 5C indicates a display state when control 510 is loaded, allowing the user to select the pages per sheet from the loaded list 514.

Control 511 is a cancel button. When the cancel button is pressed, the print settings screen 501 is closed without the changed settings being reflected. Control 512 is an OK button. When the OK button is pressed, the changed settings are reflected, and the print settings screen 501 is closed.

### Example of Print Data Editing Performed by Print-Data Editing Unit 208

Next, processing performed by the print-data editing unit 208 will be described.

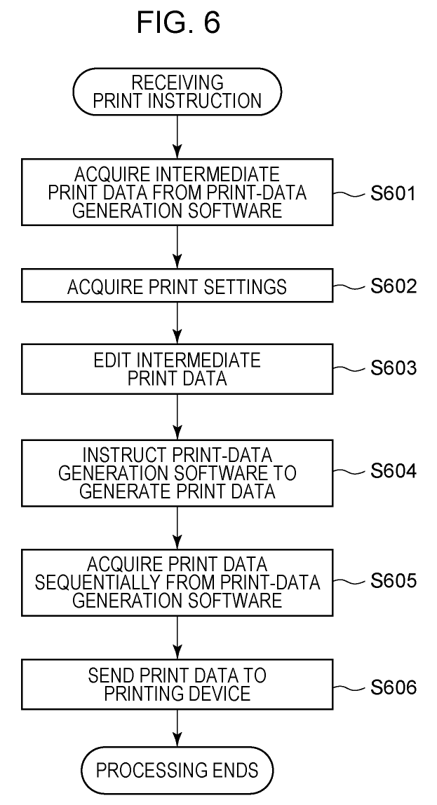

When the drawing application 201 receives a print request from the user, a print instruction is issued to the OS 212. At that time, when a process by the print-data generation software 202 is skipped by the skip control unit 206, the OS 212 activates the print-data editing unit 208 and issues a print instruction. At this time, the print-data editing unit 208 can acquire intermediate print data from the print-data generation software 202. The print-data editing unit 208 can also edit the intermediate print data acquired from the print-data generation software 202 and, for example, can apply layout processing such as an allocation process for allocating multiple pages to a single sheet to the intermediate print data. The number of pages laid out on a single sheet is, for example, two pages, four pages, six pages, nine pages, and 16 pages. A sequence of processes when the print-data editing unit 208 is activated by the OS 212 will be described with reference to the flowchart shown in FIG. 6.

The flowchart shown in FIG. 6 illustrates an example of a sequence of processes initiated when the print-data editing unit 208 receives a print instruction from the OS 212. The steps of the flowchart in FIG. 6 are implemented by the CPU 111 reading a program stored in the ROM 112 into the RAM 113 and executing it. Hereinafter, for convenience of explanation, the term "by the print-data editing unit 208" shall mean that "by the CPU 111 executing the print-data editing unit 208". This also applies to the following flowcharts.

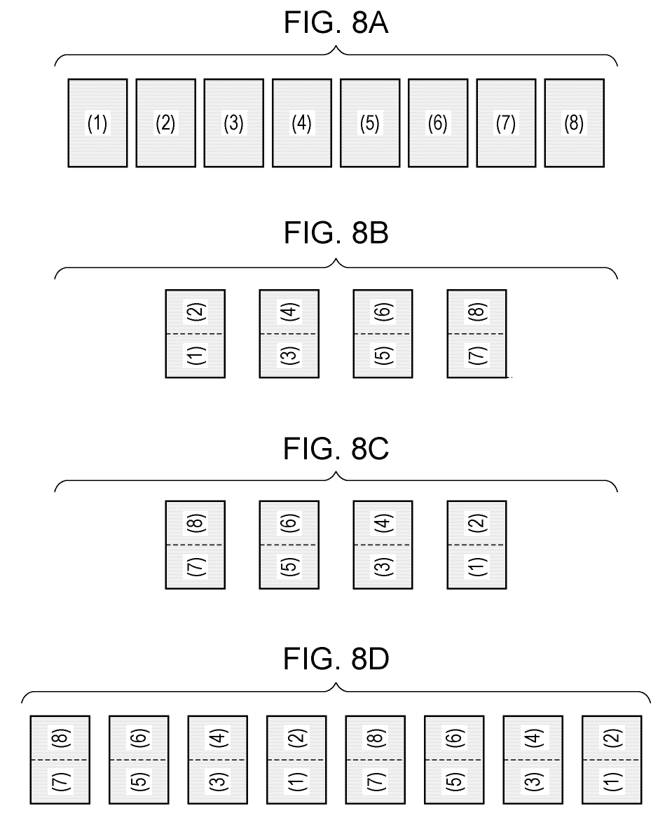

First, upon receiving a print instruction from the OS 212, in S601, the print-data editing unit 208 acquires intermediate print data from the print-data generation software 202. In the present embodiment, XML Paper Specification (XPS) is used as an example of the format of the intermediate print data. In practice, the format of the intermediate print data is not limited to XPS, and any other data format may be used. In the present embodiment, it is assumed that the print-target data is data consisting of eight A4-size pages in total, each page having a page number at the center thereof, as shown in FIG. 8A.

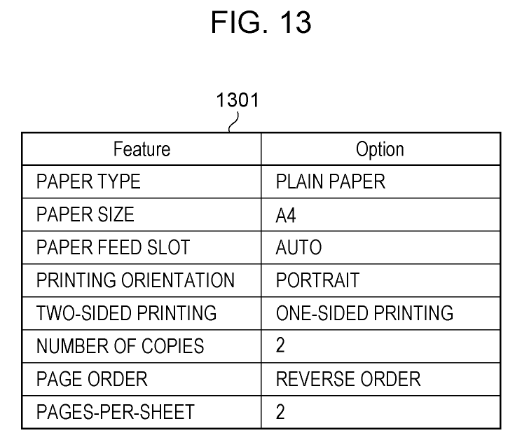

Next, in S602, the print-data editing unit 208 acquires print settings from the print-data generation software 202. The print settings are acquired with reference to PrintTicket provided together with the intermediate print data provided from the print-data generation software 202. The method for acquiring the print settings is merely illustrative. Another method may be used. For example, the print-settings-screen extension unit 205 may store print settings set via the print settings screen 501 in the shared information 210, and the print-data editing unit 208 may acquire the print settings with reference to the shared information 210. An example of a list of acquired print settings is illustrated in Table 1301 in FIG. 13. Table 1301 shows a list of print settings in the column of Feature and a list of print setting values set for the individual features in the column of Option.

Table 1301 shows that the print settings list acquired here indicates that "plain paper" is set as the paper type, "A4" as the paper size, "Auto" as the paper feed port, "Portrait" as the print orientation, and "One-sided printing" as the two-sided printing setting. The list also indicates that "2" is set as the number of copies, "Reverse" as the page order, and "2" as the pages-per-sheet. In practice, the print settings list acquired in the process of S602 is not limited to the example of Table 1301, and any other print settings may be acquired.

After acquiring, in S602, a print settings list from the print-data generation software 202, the print-data editing unit 208 edits the intermediate print data in S603 based on the acquired print settings list. The print-data editing unit 208 can perform a print-data editing process that is not supported by the print-data generation software 202. For example, the print-data generation software 202 does not support a process of editing the layout of print data, such as allocation printing. Accordingly, in the present embodiment, the print-data editing unit 208 performs an allocation process in S603. The print-data editing unit 208 performs the print-data allocation process based on the print settings list acquired in S602. In the example of Table 1301, the paper size is set to A4, and the pages-per-sheet is set to 2. Therefore, the print-data editing unit 208 edits the layout of the intermediate print data such that the eight pages of data shown in FIG. 8A are laid out two pages per A4-size sheet. FIG. 8B illustrates the layout of the intermediate print data after the print-data editing unit 208 has performed an allocation process with an allocation number of 2 on the intermediate print data shown in FIG. 8A. Through the process in S603, the intermediate print data in which two pages are laid out on an A4-size sheet is generated, as shown in FIG. 8B.

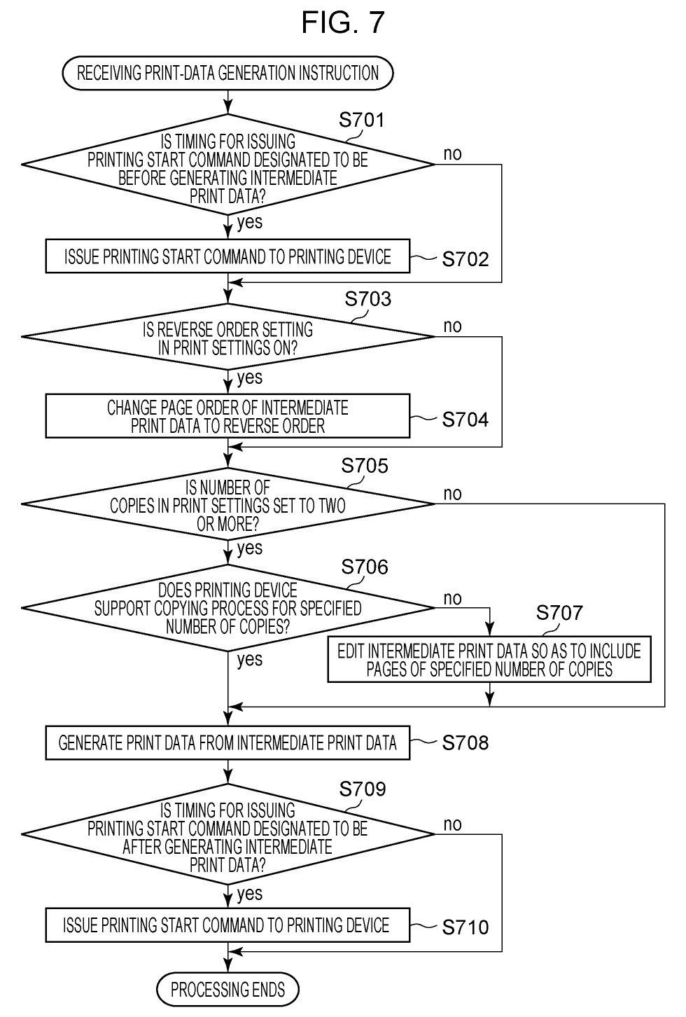

After editing the intermediate print data in S603, the print-data editing unit 208 issues an instruction to generate print data in S604. In S604, the print-data editing unit 208 issues a print-data generation instruction to the print-data generation software 202 to generate print data based on the intermediate print data edited in S603. A print-data generation process performed by the print-data generation software 202 in response to the instruction from the print-data editing unit 208 in S604 will be described with reference to FIG. 7. The flowchart shown in FIG. 7 illustrates an example of a sequence of print-data generation processes that the print-data generation software 202 executes in response to a print-data generation instruction from the print-data editing unit 208. First, in response to the print-data generation instruction from the print-data editing unit 208, the print-data generation software 202 performs a determination process of S701. In the determination process of S701, the print-data generation software 202 determines whether a timing for issuing a printing start command is designated to be before editing the intermediate print data. The timing for issuing a printing start command is designated by the print-data editing unit 208. If no start command is given, it is determined that the start timing is "before editing the intermediate print data". The timing for issuing a printing start command is either "before editing the intermediate print data" or "after editing the intermediate print data". If it is determined in S701 that the issuance timing is before editing the intermediate print data, the print-data generation software 202 performs a printing start command issuance process of S702. If in S701 it is determined that the issuance timing is after editing the intermediate print data, the process proceeds to S703.

In the present embodiment, since the timing for issuing a printing start command is not designated in the processing of the print-data editing unit 208 in FIG. 6, it is determined in S701 that the issuance timing is before editing the intermediate print data. In the printing start command issuance process of S702, specifically, the print-data generation software 202 issues a Create-job command, which is an IPP command, to the printing device 102 that performs printing. By issuing the command, the printing device 102 enters a print-data receiving state. Next, the print-data generation software 202 determines in S703 whether a reverse order setting in the print settings is on. Specifically, if a setting value for the reverse order setting in the print settings list similar to the list acquired by the print-data editing unit 208 in S602 is of a reverse order, the process proceeds to S704. If the setting value for the reverse order setting is of a forward order setting, the process proceeds to S705. In S704, the print-data generation software 202 executes a process for rearranging the page order of the intermediate print data to a reverse order. Next, in S705, the print-data generation software 202 determines whether the number of copies set in the print settings is 2 or more. If a print setting for the number of copies in a print settings list similar to the list acquired by the print-data editing unit 208 in S602 is set to 2 or more, the print-data generation software 202 proceeds to S706. If the number of copies is set to 1, the process proceeds to S708. In S706, the print-data generation software 202 determines whether the printing device 102 supports a copying process for the number of copies. Specifically, the print-data generation software 202 refers to PrintCapabilities generated by the OS 212 based on the PDC 203. The print-data generation software 202 determines whether the printing device 102 supports a copying process for the number of copies depending on whether the value of "RenderCopiesInPrinter" described in PrintCapabilities is "true". If the result of the determination in S706 is Yes, in other words, if the value of "RenderCopiesInPrinter" described in PrintCapabilities is "true", the print-data generation software 202 proceeds to S708. If the result of the determination in S706 is No, the print-data generation software 202 proceeds to S707. In other words, if the value of "RenderCopiesInPrinter" included in PrintCapabilities is "false", the print-data generation software 202 proceeds to S707. If "RenderCopiesInPrinter" itself is not included, the print-data generation software 202 proceeds to S707. In S707, the print-data generation software 202 copies the pages of the intermediate print data such that the intermediate print data includes the pages corresponding to the number of copies set in the setting for the number of copies. Thereafter, the print-data generation software 202 performs the process in S708. In S708, the print-data generation software 202 generates print data from the intermediate print data. The print data is in a format interpretable by the printing device 102. The printing device 102 practically prints on a print medium such as paper based on the received print data. Examples of a format interpretable by the printing device 102 include Printer Working Group (PWG)-Raster and Portable Document Format (PDF). In the print-data generation process in S708 of the present embodiment, the print-data generation software 202 converts intermediate print data from the XPS format to the PWG-Raster format. In practice, the intermediate print data may be in a format other than the XPS and may be in any format supported by the printing device 102 other than PWG-Raster. The format of the print data generated by the print-data generation software 202 may be selectable by the print-data editing unit 208. Thereafter, the print-data generation software 202 determines a timing for issuing a printing start command in S709. Here, the print-data generation software 202 determines whether a timing for issuing a printing start command is designated to be after editing the intermediate print data. If in S709 the timing for issuing a printing start command is designated to be after editing the intermediate print data, the print-data generation software 202 proceeds to S710. In S710, the print-data generation software 202 issues a printing start command to the printing device 102. If the timing for issuing a printing start command is not designated to be after editing the intermediate print data, the process ends.

In the present embodiment, since the timing for issuing a printing start command is not designated by the print-data editing unit 208, the timing for issuing a printing start command is treated as being before editing the intermediate print data, and the printing start command is issued in S702. For this reason, the process in S710 is not executed. Thus, when in S604 the print-data editing unit 208 issues a print-data generation instruction to the print-data generation software 202, the sequence of steps from S701 to S710 are executed. Here, FIGS. 8A to 8D illustrate the state of print data when the sequence of steps from S701 to S710 is executed in the case where the print settings list in Table 1301 is set as print settings. In the example of print settings in Table 1301, the intermediate print data at the point where the print-data generation software 202 is instructed to generate print data, that is, the point in time when the flowchart in FIG. 7 is started is, in the state shown in FIG. 8B. Here, according to Table 1301, since the print setting is set to reverse order printing, it is determined as Yes in S703, and the changing process of S704 is executed. At this point in time, the page order of the intermediate print data is reversed to enter the state shown in FIG. 8C. Since the print setting for the number of copies is 2, it is determined as Yes in S705. According to information 401, RenderCopiesInPrinter is defined as "false", the printing device 102 does not support a copying process for the number of copies, and therefore, it is determined as No in S706. As a result, the print-data generation software 202 copies the intermediate print data so as to include pages of the number of copies designated by control 508 in FIG. 5A, and therefore, the intermediate print data enters the state shown in FIG. 8D. Thus, in the example of the print settings in Table 1301, the layout of the final print data enters the state as shown in FIG. 8D by the processes performed by the print-data editing unit 208 and the print-data generation software 202.

When the process in S604 is executed, and the print-data generation software 202 starts to generate print data, the print-data editing unit 208 proceeds to S605, enabling the generated print data to be acquired in sequence. Specifically, the print-data generation software 202 starts the generation from the first page of the final print data, and the print-data editing unit 208 can sequentially acquire print data directly after the data of the first page is generated. The print-data editing unit 208 sequentially transmits the generated print data to the printing device 102 in the next step S606. According to this configuration, transmitting print data to the printing device 102 as soon as the first page of the print data is generated eliminates the need for waiting for all of the print data to be generated, thereby enabling printing to be started more quickly.

This is an example of a sequence of processes that is started when the print-data editing unit 208 receives a print instruction from the OS 212. In the present embodiment, the print-data editing unit 208 can perform processes that are not supported by the print-data generation software 202, such as layout editing, on the intermediate print data.

### Problem

However, in the example described above, printing may fail because of the specifications of printing using the IPP. In printing using the IPP, as shown in the example of information 1211, when a predetermined time has elapsed after a printing start command is issued to the printing device 102 until print data is transmitted to the printing device 102, the printing device 102 cancels the print job. In the present embodiment, after the print-data generation software 202 issues a printing start command to the printing device 102 in S702, the intermediate print data is edited in the steps from S703 to S707. The reverse order process in S704 and the copying process for the number of copies in S707 need to be executed after all of the pages have been read. For example, when the intermediate print data includes a large number of pages, and a very large number is set for the print setting for the number of copies, the steps from S703 to S707 will take much time in proportion to the large number of pages and copies. In other words, the time from issuance of the printing start command in S702 to the start of transmission of print data in S606 may exceed the time limit indicated in the example of information 1211 (resulting in a time-out), which may cause printing to fail.

Accordingly, in the present embodiment, a configuration for solving the above problem will be described hereinbelow. Hereinafter, components and processes not specifically mentioned are assumed to be the same as those specified in the foregoing examples.

### Example of Configuration for Controlling Order of Print-Data Generation Processing of Print-Data Generation Software 202

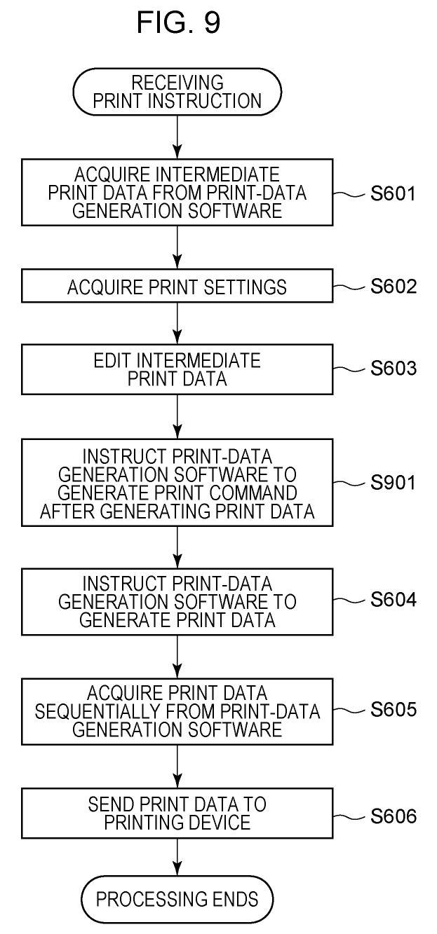

In the present embodiment, a configuration for solving the above problem will be described in which the order of print-data generation processing by the print-data generation software 202 is controlled. The above problem arises because the print-data generation software 202 issues a printing start command to the printing device 102 immediately after receiving a print-data generation instruction from the print-data editing unit 208. Accordingly, in the present embodiment, control is performed such that the print-data generation software 202, upon receiving a print-data generation instruction from the print-data editing unit 208, and upon completion of editing of the intermediate print data, issues a printing start command to the printing device 102 when generation of the print data is started. FIG. 9 is a flowchart of a sequence of processes in this configuration executed when the print-data editing unit 208 receives a print instruction from the OS 212. The steps of the flowchart in FIG. 9 are implemented by the CPU 111 reading a program stored in the ROM 112 into the RAM 113 and executing it. Of the processes in FIG. 9, the same processes as those in FIG. 6 are denoted by the same numerals, and descriptions thereof will be omitted. When receiving a print instruction from the OS 212, the print-data editing unit 208 executes the steps from S601 to S603.

Thereafter, in S901, the CPU 111 provides an instruction for an issuance timing of a printing start command to the print-data generation software 202. Specifically, the print-data editing unit 208 instructs the print-data generation software 202 to issue a printing start command after editing the intermediate print data. In response to the instruction, the print-data generation software 202, upon receiving a print-data generation instruction from the print-data editing unit 208, and upon completion of editing of the intermediate print data, issues a printing start command to the printing device 102 when generation of the print data is started.

FIG. 7 is a flowchart of a sequence of processes of print-data generation processing by the print-data generation software 202. The details of the processes have been described above, and descriptions thereof will be omitted. According to the present embodiment, the timing for issuing a printing start command is designated to be after editing of the intermediate print data by the print-data editing unit 208, the result of the determination in S701 is No. Thereafter, the print-data generation software 202 executes the steps from S703 to S708. The determination in S709 is Yes, and the print-data generation software 202 issues a printing start command in S710. Thus, according to the present embodiment, the print-data generation software 202 issues a print command to the printing device 102 upon starting print-data generation processing.

This configuration allows the print-data editing unit 208 to start a process for transmitting print data to the printing device 102 in S606 as soon as the print data is generated from the intermediate print data in S708. In other words, when a printing start command is issued by the print-data generation software 202, the print-data editing unit 208 can transmit print data to the printing device 102. Accordingly, in the present embodiment, the time from issuance of a printing start command to the printing device 102 to the start of transmission of print data is minimized, thereby preventing print failure due to a time limit for accepting continuous operations of the printing device 102 being exceeded.

### Second Embodiment

The first embodiment describes an example of a configuration for preventing print failure due to a time limit for accepting continuous operations of the printing device 102 being exceeded by controlling the order of the print-data generation processing by the print-data generation software 202. However, since the print-data generation software 202 is provided as a standard component of the OS 212, the order of the print-data generation processing may not easily be controlled. Accordingly, a second embodiment shows an example of a configuration for preventing print failure due to a time limit for accepting continuous operations of the printing device 102 being exceeded without controlling the order of processes by the print-data generation software 202. Hereinafter, configurations and processes not specifically mentioned are assumed to be the same as those in the first embodiment.

### Example of Configuration for Reducing Time for Print-Data Generation Processing of Print-Data Generation Software 202

This example describes a configuration for solving the above problem, in which part of the print-data generation processing to be performed by the print-data generation software 202 is executed by the print-data editing unit 208. This can reduce the time from issuance of a printing start command by the print-data generation software 202 to the printing device 102 to generation of print data, thereby preventing print failure due to a time limit for accepting continuous operations of the printing device 102 being exceeded.

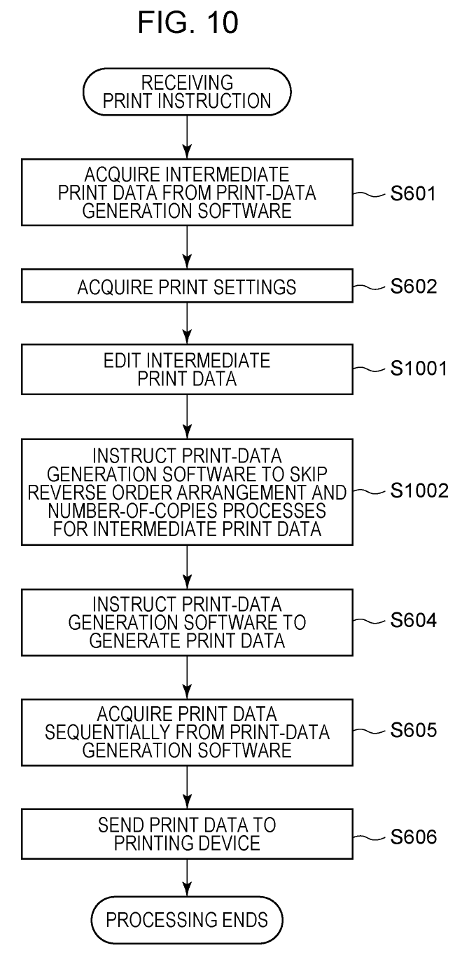

FIG. 10 is a flowchart of a sequence of processes executed when the print-data editing unit 208 is activated by the OS 212. The steps of the flowchart in FIG. 10 are implemented by the CPU 111 reading a program stored in the ROM 112 into the RAM 113 and executing it. Of the processes in FIG. 10, the same processes as those of the flowchart in FIG. 6 are denoted by the same numerals, and detailed descriptions thereof will be omitted.

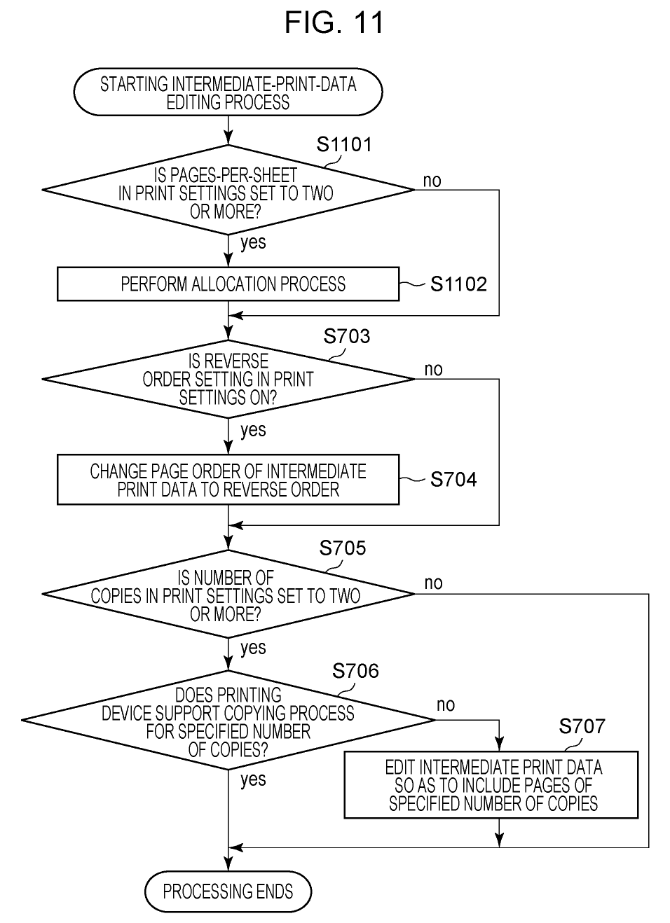

When the print-data editing unit 208 is activated by the OS 212, the processes in S601 and S602 are executed. Thereafter, a print-data editing process is performed in S1001. In the present embodiment, part of the print-data generation processing by the print-data generation software 202 is executed by the print-data editing unit 208. FIG. 11 is a flowchart of a sequence of print-data editing processes performed by the print-data editing unit 208. The same processes as those of the flowchart in FIG. 7 are denoted by the same numerals, and detailed descriptions thereof will be omitted. First, when the print-data editing unit 208 starts a print-data editing process, the print-data editing unit 208 determines in S1101 whether the setting for pages-per-sheet in the print settings list acquired in S602 in the flowchart shown in FIG. 10 is set to 2 or more. If in S1101 it is determined as Yes, the print-data editing unit 208 proceeds to S1102. If in S1101 it is determined as No, the print-data editing unit 208 proceeds to S703.

In S1102, the print-data editing unit 208 performs an allocation process according to the setting for pages-per-sheet acquired in S602 of the flowchart shown in FIG. 10. In the example of Table 1301, the paper size is set to A4, and the pages-per-sheet is set to 2. It is assumed that the intermediate print data acquired by the print-data editing unit 208 from the print-data generation software 202 in S601 of FIG. 10 is in the state shown in FIG. 8A. In this case, the print-data editing unit 208 edits the layout of the intermediate print data such that the eight pages of data shown in FIG. 8A is laid out two pages per A4-size sheet. When the print-data editing unit 208 executes the allocation process in S1102, then the print-data editing unit 208 executes the steps from S703 to S707.

In other words, in the present embodiment, part of the print-data generation processing to be executed by the print-data generation software 202, specifically steps from S703 to S707, is executed by the print-data editing unit 208 in advance. As a result, when the print-data editing unit 208 executes the print-data editing process of S1001, the intermediate print data assumes the state shown in FIG. 8D.

After executing the print-data editing process of S1001, the print-data editing unit 208 provides a skip instruction in S1002. In the skip instruction in S1002, the print-data editing unit 208 instructs the print-data generation software 202 to skip an intermediate-print-data editing process for the reverse order arrangement and the number of copies. Specifically, the print-data editing unit 208 instructs the print-data generation software 202 to skip the steps from S703 to S707 when executing the print-data generation processing shown in FIG. 7. This is because the steps from S703 to S707 have already been executed by the print-data editing unit 208 in S1001, and therefore, there is no need for the print-data generation software 202 to execute them. The print-data editing unit 208 uses the API of the OS 212 to cause the print-data generation software 202 to generate print data. The API refers to flag information for skipping part of the print-data generation processing. The print-data editing unit 208 provides the skip instruction in S1002 by operating the flag information.

After providing the skip instruction in S1002, the print-data editing unit 208 provides a print-data generation instruction in S604. Thus, the print-data generation software 202 starts the print-data generation processing shown in the flowchart of FIG. 7. However, the steps from S703 to S707 have been skipped in S1002. For this reason, the print-data generation software 202 can execute the print-data generation processing of S708 immediately after the printing start command generation process of S702. Furthermore, since the steps from S703 to S707 have been skipped, print data of the first page is immediately generated in the print-data generation processing of S708. Therefore, the print-data transmission process of S606 is executed soon after the printing start command is issued in S702, thereby preventing print failure due to a time limit for accepting the continuous operations of the printing device 102 being exceeded.

Thus, the present embodiment describes a configuration for preventing print failure due to a time limit for accepting the continuous operations of the printing device 102 being exceeded by executing part of the print-data generation processing to be executed by the print-data generation software 202 using the print-data editing unit 208.

### Third Embodiment

Although the first embodiment and the second embodiment have been described as different configurations, a configuration in which the first and second embodiments are combined may also be adopted. Specifically, according to the present embodiment, the print-data editing unit 208 performs the intermediate-print-data editing process of the print-data generation software 202 as in the second embodiment. The print-data editing unit 208 instructs the print-data generation software 202 to issue a printing start command after editing intermediate print data as in the first embodiment. The print-data editing unit 208 may execute part of the intermediate-print-data editing process by the print-data generation software 202, and the other of the intermediate-print-data editing process may be executed by the print-data generation software 202. For example, the process for reverse order arrangement in S704 may be performed by the print-data editing unit 208, and the process for the number of copies in S707 may be performed by the print-data generation software 202. Which of the print-data editing unit 208 and the print-data generation software 202 performs which intermediate-print-data editing process may be determined based on various considerations. For example, if it is more effective that some intermediate-print-data editing process be executed by the print-data generation software 202 from the viewpoint of performance speed, such a configuration may be adopted. In contrast, if it is more effective that some intermediate-print-data editing process be executed by the print-data editing unit 208 from the viewpoint of performance speed, such a configuration may be adopted. When some intermediate-print-data editing process is executed by the print-data generation software 202, the printing start command may be issued after the intermediate print data is generated. For this reason, in the configuration of this embodiment, it is more effective to combine the first embodiment and the second embodiment. According to the third embodiment, not only the problem of print failure due to a time limit for accepting the continuous operations of the printing device 102 can be solved, but also the effect of improving the performance can be provided.

This technique makes it possible to provide enhanced functions as an extension application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-197636, filed November 12, 2024, which is hereby incorporated by reference herein in its entirety.

What is claimed is:

1. A non-transitory computer-readable storage medium storing an application program that is configured to cooperate with a standard driver provided by a provider of an operating system of an information processing apparatus, wherein the application program, when executed, causes the information processing apparatus to perform a control method comprising:
causing the standard driver of the information processing apparatus to execute a changing process of changing a page order of a plurality of pages of image data generated by an image editing application program to a page order for reverse printing in an order opposite to the page order; and
after the standard driver has completed the changing process, causing the operating system of the information processing apparatus to instruct the standard driver to generate print data based on the image data.

2. The storage medium according to claim 1, wherein the control method further comprises:
causing the information processing apparatus to execute, by the standard driver, a copying process of copying, by a designated number of copies, the image data whose page order has been changed in the changing process.

3. The storage medium according to claim 2, wherein, in the instructing, after the standard driver has completed the changing process and the copying process, the standard driver is instructed to generate the print data.

4. The storage medium according to claim 2, wherein the control method further comprises:
causing the information processing apparatus to execute, by the standard driver, an allocation process of allocating two or more pages included in the plurality of pages of image data to a single sheet.

5. The storage medium according to claim 4, wherein, in the instructing, after the standard driver has completed the allocation process, the changing process, and the copying process, the standard driver is instructed to generate the print data.

6. The storage medium according to claim 1, wherein the control method further comprises:
causing the information processing apparatus to execute a transmission process of transmitting, to a printing device, the print data generated according to the instruction.

7. The storage medium according to claim 6, wherein, in the transmission process, the print data is transmitted to the printing device in accordance with the Internet Printing Protocol.

8. A non-transitory computer-readable storage medium storing an application program that supports a standard driver provided by a provider of an operating system of an information processing apparatus, wherein a control method is executed by executing the application program, the control method comprising:
executing a changing process of changing a page order of a plurality of pages of image data generated by an image editing application program to a page order for reverse printing in an order opposite to the page order; and
instructing the standard driver to generate print data based on the image data after the changing process has been completed.

9. The storage medium according to claim 8, wherein the control method further comprises:
causing the information processing apparatus to execute a copying process of copying, by a designated number of copies, the image data whose page order has been changed in the changing process.

10. The storage medium according to claim 9, wherein, in the instructing, after the changing process and the copying process have been completed, the standard driver is instructed to generate the print data.

11. The storage medium according to claim 9, wherein the control method further comprises:
causing the information processing apparatus to execute an allocation process of allocating two or more pages included in the plurality of pages of image data to a single sheet.

12. The storage medium according to claim 11, wherein, in the instructing, after the standard driver has completed the allocation process, the changing process, and the copying process, the standard driver is instructed to generate the print data.

13. The storage medium according to claim 8, wherein the control method further comprises:
causing the information processing apparatus to execute a transmission process of transmitting, to a printing device, the print data generated according to the instruction.

14. The storage medium according to claim 13, wherein, in the transmission process, the print data is transmitted to the printing device in accordance with the Internet Printing Protocol.

15. A method for supporting a standard driver provided by a provider of an operating system of an information processing apparatus, the method comprising:
causing the standard driver of the information processing apparatus to execute, by executing an application program, a changing process for changing a page order of a plurality of pages of image data generated by an image editing application program to a page order for reverse printing in an order opposite to the page order; and
after the standard driver has completed the changing process, causing the operating system of the information processing apparatus to instruct the standard driver, by executing the application program, to generate print data based on the image data.

16. An information processing apparatus comprising an application program configured to support a standard driver provided by a provider of an operating system, the information processing apparatus comprising:
a processor configured to execute, by executing the application program, a changing process for changing a page order of a plurality of pages of image data generated by an image editing application program to a page order for reverse printing in an order opposite to the page order; and
after the standard driver has completed the changing process, causing the operating system of the information processing apparatus to instruct the standard driver to generate print data based on the image data.
